(19) United States
(12) Patent Application Publication
(10) Pub. No.: US 2021/0031136 A1
(43) Pub. Date: Feb. 4, 2021

(54) CARBON DIOXIDE CAPTURE SYSTEM AND METHOD OF OPERATING CARBON DIOXIDE CAPTURE SYSTEM

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Koshito FUJITA, Yokohama Kanagawa (JP); Mitsuru UDATSU, Kawasaki Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 16/937,729

(22) Filed: Jul. 24, 2020

(30) Foreign Application Priority Data
Jul. 30, 2019 (JP) 2019-140056

(51) Int. Cl. B01D 53/14; B01D 53/18

(52) U.S. Cl. CPC B01D 53/1425; B01D 53/1493; B01D 2252/204; B01D 53/18; B01D 53/1475

(57) ABSTRACT

A carbon dioxide capture system according to the embodiment includes: a carbon dioxide capturer configured to cause a carbon dioxide contained in a combustion exhaust gas into an absorbing liquid containing an amine; a first washer configured to wash the combustion exhaust gas from the carbon dioxide capturer with a mist of a first cleaning liquid sprayed by a spray to capture the amine contained in the combustion exhaust gas; and a cleaning liquid mist capturer configured to capture the mist of the first cleaning liquid contained in the combustion exhaust gas from the first washer. The first washer has a receiver arranged below the spray, and a washing-capturing space arranged between the spray and the receiver. In the washing-capturing space, the mist of the first cleaning liquid comes into gas-liquid contact with the combustion exhaust gas while freely dropping.

### CROSS-REFERENCE TO RELATED APPLICATIONS

This application is based upon and claims the benefit of priority from Japanese Patent Application No. 2019-140056, filed Jul. 30, 2019; the entire contents of which are incorporated herein by reference.

### FIELD

Embodiments of the present invention relate to a carbon dioxide capture system and a method of operating the carbon dioxide capture system.

### BACKGROUND

In recent years, the greenhouse effect of carbon dioxide contained in a combustion exhaust gas generated at the time of burning fossil fuels has been pointed out as one of the causes of global warming.

Under such circumstances, in a thermal power plant or the like that uses a large amount of fossil fuel, a carbon dioxide capture system is being studied which suppresses the release of carbon dioxide contained in the combustion exhaust gas generated by burning fossil fuel into the atmosphere. In the carbon dioxide capture system, the combustion exhaust gas is brought into contact with an amine-based absorbing liquid, and carbon dioxide is separated and captured from the combustion exhaust gas.

More specifically, the carbon dioxide capture system includes an absorption column that causes carbon dioxide contained in a combustion exhaust gas to be absorbed into an amine-based absorbing liquid and a regeneration column that heats the absorbing liquid (rich liquid) absorbing the carbon dioxide supplied from the absorption column to release the carbon dioxide from the rich liquid and regenerates the absorbing liquid. A reboiler for supplying a heat source is connected to the regeneration column, and the rich liquid is heated in the regeneration column. The absorbing liquid (lean liquid) regenerated in the regeneration column is supplied to the absorption column, and the absorbing liquid is configured to circulate in this system.

However, in such a carbon dioxide capture system, the combustion exhaust gas (decarbonated combustion exhaust gas) from which carbon dioxide is absorbed into the amine-based absorbing liquid in the absorption column accompanies an amine when released into the atmosphere from the absorption column. That is, since a large amount of combustion exhaust gas is released from a thermal power plant or the like, a large amount of an amino group-containing compound (amine) may be released along with the decarbonated combustion exhaust gas. For this reason, when the carbon dioxide capture system is used in the thermal power plant, it is desired to effectively reduce the amine accompanying the decarbonated combustion exhaust gas in the absorption column and released into the atmosphere.

### BRIEF DESCRIPTION OF THE DRAWINGS

FIG. 1 is a diagram illustrating an overall configuration of a carbon dioxide capture system according to a first embodiment of the present invention;

FIG. 2 is a diagram illustrating an overall configuration of a carbon dioxide capture system according to a second embodiment of the present invention;

FIG. 3 is a diagram illustrating an overall configuration of a carbon dioxide capture system according to a third embodiment of the present invention;

FIG. 4 is a graph illustrating a relationship between a flow rate of a cleaning liquid and a removal rate of mist-like amine in the carbon dioxide capture system illustrated in FIG. 3,

FIG. 5 is a diagram illustrating an overall configuration of a carbon dioxide capture system according to a fourth embodiment of the present invention; and

FIG. 6 is a diagram illustrating an overall configuration of a carbon dioxide capture system according to a fifth embodiment of the present invention.

### DETAILED DESCRIPTION

A carbon dioxide capture system according to the embodiment includes: a carbon dioxide capturer configured to cause a carbon dioxide contained in a combustion exhaust gas to be absorbed into an absorbing liquid containing an amine; and a first washer configured to wash the combustion exhaust gas discharged from the carbon dioxide capturer with a mist of a first cleaning liquid sprayed by a spray to capture the amine accompanying the combustion exhaust gas. Further, the carbon dioxide capture system includes a cleaning liquid mist capturer configured to capture the mist of the first cleaning liquid accompanying the combustion exhaust gas discharged from the first washer.

A method of operating a carbon dioxide capture system according to the embodiment includes: causing a carbon dioxide contained in a combustion exhaust gas to be absorbed into an absorbing liquid containing an amine in a carbon dioxide capturer; and washing the combustion exhaust gas discharged from the carbon dioxide capturer with a mist of a first cleaning liquid sprayed by a spray in a first washer to capture the amine accompanying the combustion exhaust gas. Further, the method of operating a carbon dioxide capture system includes capturing the mist of the first cleaning liquid accompanying the combustion exhaust gas discharged from the first washer.

Hereinafter, with reference to the drawings, a description will be given of a carbon dioxide capture system and a method of operating the carbon dioxide capture system in an embodiment of the present invention.

### First Embodiment

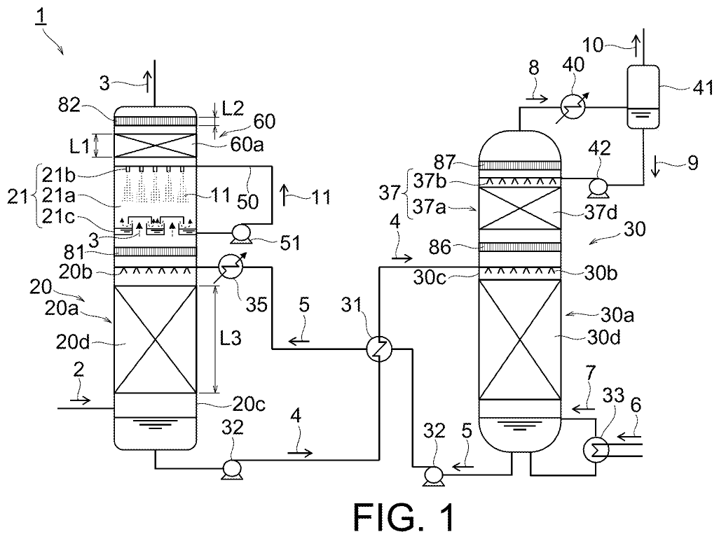

First, a carbon dioxide capture system and a method of operating the carbon dioxide capture system according to a first embodiment of the present invention will be described with reference to FIG. 1.

As illustrated in FIG. 1, a carbon dioxide capture system 1 includes an absorption column 20 that causes carbon dioxide contained in a combustion exhaust gas 2 to be absorbed into an amine-containing absorbing liquid, and a regeneration column 30 that releases the carbon dioxide from the absorbing liquid absorbing the carbon dioxide supplied from the absorption column 20 to regenerate the absorbing liquid. The combustion exhaust gas 2 from which the carbon dioxide is absorbed into the absorbing liquid in the absorption column 20 is discharged as a decarbonated combustion exhaust gas 3 (described later) from the absorption column 20. Further, carbon dioxide is discharged as a carbon dioxide-containing gas 8 (carbon dioxide-containing vapor) together with vapors from the regeneration column 30. Incidentally, the combustion exhaust gas 2 supplied to the absorption column 20 is not particularly limited. However, the combustion exhaust gas may be, for example, a combustion exhaust gas of a boiler (not illustrated) of a thermal power plant, a process exhaust gas, or the like, and may be supplied to the absorption column 20 after a cooling process as needed.

The absorbing liquid circulates between the absorption column 20 and the regeneration column 30. The absorbing liquid absorbs carbon dioxide in the absorption column 20 to be a rich liquid 4, and releases the carbon dioxide in the regeneration column 30 to be a lean liquid 5. The absorbing liquid is not particularly limited. However, for example, alcoholic hydroxyl group-containing primary amine such as monoethanolamine and 2-amino-2-methyl-1-propanol, alcoholic hydroxyl group-containing secondary amine such as diethanolamine and 2-methylaminoethanol, alcoholic hydroxyl group-containing tertiary amine such as triethanolamine and N-methyldiethanolamine, polyethylene polyamine such as ethylenediamine, triethylenediamine, and diethylenetriamine, piperazine, piperidine, cyclic amine such as pyrrolidine, polyamine such as xylylenediamine, amino acid such as methylaminocarboxylic acid, and the like, and mixtures thereof can be used. These amine compounds are usually used as an aqueous solution of 10 to 70% by weight. In addition, a carbon dioxide absorption promoter or a corrosion inhibitor, and further, methanol, polyethylene glycol, sulfolane, or the like as another medium can be added to the absorbing liquid.

The absorption column 20 includes a carbon dioxide capturer 20a, a liquid diffuser 20b arranged above the carbon dioxide capturer 20a, and an absorption column container 20c that houses the carbon dioxide capturer 20a and the liquid diffuser 20b.

The carbon dioxide capturer 20a is configured as a countercurrent gas-liquid contact device. As an example, the carbon dioxide capturer 20a includes a carbon dioxide capture packed bed 20d. The carbon dioxide capture packed bed 20d is configured by an internal structure such as packing or particles filled inside to increase the gas-liquid contact area. While the lean liquid 5 supplied from the regeneration column 30 flows down on the surface of the internal structure, the lean liquid 5 is brought into gas-liquid contact with carbon dioxide contained in the combustion exhaust gas 2, and the carbon dioxide is absorbed into the lean liquid 5. Accordingly, the carbon dioxide is captured (or removed) from the combustion exhaust gas 2.

The liquid diffuser 20b is configured to diffuse and drop the lean liquid 5 toward the carbon dioxide capturer 20a. From this liquid diffuser 20b, the lean liquid 5 is supplied to the surface of the internal structure of the carbon dioxide capture packed bed 20d. The pressure of the lean liquid 5 supplied to the liquid diffuser 20b is a pressure that is not so high as compared with the inner pressure of the absorption column 20, and the liquid diffuser 20b drops the lean liquid 5 to the carbon dioxide capture packed bed 20d substantially by the action of gravity rather than force.

In the absorption column container 20c, a first washer 21, a cleaning liquid mist capturer 60, and demisters 81 and 82 which will be described later are housed together with the carbon dioxide capture packed bed 20d and the liquid diffuser 20b. The absorption column container 20c is configured to receive the combustion exhaust gas 2 from the lower portion of the absorption column container 20c and discharge the combustion exhaust gas 2 as the decarbonated combustion exhaust gas 3 described later from the top of the absorption column container 20c.

The combustion exhaust gas 2 containing carbon dioxide discharged from the outside of the carbon dioxide capture system 1 such as the boiler described above is supplied to a lower portion of the absorption column 20 by a blower (not illustrated). The supplied combustion exhaust gas 2 rises toward the carbon dioxide capture packed bed 20d of the carbon dioxide capturer 20a in the absorption column 20. On the other hand, the lean liquid 5 from the regeneration column 30 is supplied to the liquid diffuser 20b and drops from the liquid diffuser 20b. The lean liquid 5, then, is supplied to the carbon dioxide capture packed bed 20d to flow down on the surface of the internal structure of the carbon dioxide capture packed bed 20d. In the carbon dioxide capture packed bed 20d, the combustion exhaust gas 2 and the lean liquid 5 come into gas-liquid contact, and the carbon dioxide contained in the combustion exhaust gas 2 is absorbed into the lean liquid 5 to generate the rich liquid 4.

The generated rich liquid 4 is once stored in the lower portion of the absorption column container 20c and is discharged from the lower portion. The combustion exhaust gas 2 subjected to gas-liquid contact with the lean liquid 5 is subjected to removal of carbon dioxide, and further rises as the decarbonated combustion exhaust gas 3 from the carbon dioxide capture packed bed 20d in the absorption column 20.

A heat exchanger 31 is arranged between the absorption column 20 and the regeneration column 30. A rich liquid pump 32 is arranged between the absorption column 20 and the heat exchanger 31, and the rich liquid 4 discharged from the absorption column 20 is supplied to the regeneration column 30 through the heat exchanger 31 by the rich liquid pump 32. The heat exchanger 31 exchanges heat between the rich liquid 4 supplied from the absorption column 20 to the regeneration column 30 and the lean liquid 5 supplied from the regeneration column 30 to the absorption column 20. As a result, the lean liquid 5 serves as a heat source, and the rich liquid 4 is heated to a desired temperature. In other words, the rich liquid 4 serves as a cold heat source, and the lean liquid 5 is cooled to a desired temperature.

The regeneration column 30 includes an amine regenerator 30a, a liquid diffuser 30b arranged above the amine regenerator 30a, and a regeneration column container 30c that houses the amine regenerator 30a and the liquid diffuser 30b.

The amine regenerator 30a is configured as a countercurrent gas-liquid contact device. As an example, the amine regenerator 30a includes an amine regeneration packed bed 30d. The amine regeneration packed bed 30d is configured by an internal structure such as packing or particles filled inside to increase the gas-liquid contact area. While the rich liquid 4 supplied from the absorption column 20 flows down on the surface of the internal structure, the rich liquid 4 is brought into gas-liquid contact with a vapor 7 described later, and the carbon dioxide is released from the rich liquid 4. Accordingly, the carbon dioxide is captured (or removed) from the rich liquid 4.

The liquid diffuser 30b is configured to diffuse and drop the rich liquid 4 toward the amine regenerator 30a. The rich liquid 4 is supplied to the surface of the internal structure of the amine regeneration packed bed 30d. The pressure of the rich liquid 4 supplied to the liquid diffuser 30b is a pressure that is not so high as compared with the inner pressure of the regeneration column 30, and the liquid diffuser 30b drops the rich liquid 4 to the amine regenerator 30a substantially by the action of gravity rather than force.

In the regeneration column container 30c, a regeneration column washer 37 and demisters 86 and 87 which will be described later are housed together with the amine regeneration packed bed 30d and the liquid diffuser 30b. The regeneration column container 30c is configured to discharge the carbon dioxide-containing gas 8 released from the rich liquid 4 from the top of the regeneration column container 30c.

The reboiler 33 is connected to the regeneration column 30. The reboiler 33 heats the lean liquid 5 supplied from the regeneration column 30 by the heating medium 6 to generate the vapor 7, and supplies the generated vapor 7 to the regeneration column 30. More specifically, a part of the lean liquid 5 discharged from the lower portion of the regeneration column 30 is supplied to the reboiler 33, and a high-temperature vapor serving as the heating medium 6 is supplied from the outside such as a turbine (not illustrated) or the like. The lean liquid 5 supplied to the reboiler 33 is heated by exchanging heat with the heating medium 6, and the vapor 7 is generated from the lean liquid 5. The generated vapor 7 is supplied to the lower portion of the regeneration column 30 and heats the lean liquid 5 in the regeneration column 30. Incidentally, the heating medium 6 supplied to the reboiler 33 is not limited to high-temperature vapor from the turbine.

The vapor 7 is supplied from the reboiler 33 to the lower portion of the regeneration column 30, and rises toward the amine regeneration packed bed 30d of the amine regenerator 30a in the regeneration column 30. On the other hand, the rich liquid 4 from the absorption column 20 is supplied to the liquid diffuser 30b and drops from the liquid diffuser 30b. The rich liquid 4, then, is supplied to the amine regeneration packed bed 30d to flow down on the surface of the internal structure of the amine regeneration packed bed 30d. In the amine regeneration packed bed 30d, the rich liquid 4 and the vapor 7 come into gas-liquid contact, and the carbon dioxide gas is released from the rich liquid 4 to generate the lean liquid 5. In this way, the absorbing liquid is regenerated in the regeneration column 30.

The generated lean liquid 5 is discharged from the lower portion of the regeneration column 30. The vapor 7 subjected to gas-liquid contact with the rich liquid 4 is accompanied by carbon dioxide and is discharged from the top of the regeneration column 30 as the carbon dioxide-containing gas 8. The discharged carbon dioxide-containing gas 8 also contains vapors.

A lean liquid pump 34 is arranged between the regeneration column 30 and the heat exchanger 31. The lean liquid 5 discharged from the regeneration column 30 is supplied to the absorption column 20 through the above-described heat exchanger 31 by the lean liquid pump 34. As described above, the heat exchanger 31 cools the lean liquid 5 supplied from the regeneration column 30 to the absorption column 20 by exchanging heat with the rich liquid 4 supplied from the absorption column 20 to the regeneration column 30. In addition, a lean liquid cooler 35 is arranged between the heat exchanger 31 and the absorption column 20. In the lean liquid cooler 35, a cooling medium such as cooling water (for example, cooling water of a cooling tower or seawater) is supplied from the outside, and the lean liquid 5 cooled in the heat exchanger 31 is further cooled to a desired temperature.

The lean liquid 5 cooled in the lean liquid cooler 35 is supplied to the liquid diffuser 20b of the absorption column 20 and drops from the liquid diffuser 20b. The lean liquid, then, is supplied to the carbon dioxide capture packed bed 20d of the carbon dioxide capturer 20a to flow down on the surface of the internal structure of the carbon dioxide capture packed bed 20d. In the carbon dioxide capture packed bed 20d, the lean liquid 5 come into gas-liquid contact with the combustion exhaust gas 2, and the carbon dioxide contained in the combustion exhaust gas 2 is absorbed into the lean liquid 5 to generate the rich liquid 4. In this way, in the carbon dioxide capture system 1, the absorbing liquid circulates while repeatedly becoming the state of the lean liquid 5 and the state of the rich liquid 4.

The carbon dioxide capture system 1 illustrated in FIG. 1 includes a gas cooler 40 that cools the carbon dioxide-containing gas 8 discharged from the top of the regeneration column 30 to condense vapors to generate condensed water 9 and a gas-liquid separator 41 that separates the condensed water 9 generated by the gas cooler 40 from the carbon dioxide-containing gas 8. In this way, water contained in the carbon dioxide-containing gas 8 is reduced, and the carbon dioxide-containing gas 8 is discharged as the carbon dioxide gas 10 from the gas-liquid separator 41. The discharged carbon dioxide gas 10 is supplied to equipment (not illustrated) and stored. On the other hand, the condensed water 9 separated in the gas-liquid separator 41 is supplied to the regeneration column 30 by the condensed water pump 42 and mixed with the absorbing liquid. Incidentally, the gas cooler 40 is externally supplied with a cooling medium (for example, cooling water of a cleaning tower or seawater) for cooling the carbon dioxide-containing gas 8.

Incidentally, in the absorption column 20, the first washer 21 and the cleaning liquid mist capturer 60 are housed. Among them, the first washer 21 washes the decarbonated combustion exhaust gas 3 discharged from the carbon dioxide capturer 20a with the first cleaning liquid 11 (first washing water) and captures the amine as an absorbing liquid component accompanying the decarbonated combustion exhaust gas 3. The first washer 21 is arranged above the liquid diffuser 20b.

The first washer 21 includes a washing-capturing space 21a, a spray 21b arranged above the washing-capturing space 21a, and a first receiver 21c arranged below the washing-capturing space 21a.

The washing-capturing space 21a is a space arranged between the spray 21b and the first receiver 21c. The first cleaning liquid 11 is sprayed from the spray 21b into the washing-capturing space 21a. The sprayed first cleaning liquid 11 comes into gas-liquid contact with the rising decarbonated combustion exhaust gas 3 while freely dropping in a mist state in the washing-capturing space 21a (that is, dropping without contacting the surface of a structure or the like in the space). Accordingly, the amine accompanying the decarbonated combustion exhaust gas 3 is captured. In the first washer 21, the mist-like amine can be effectively captured, and the gaseous amine can also be effectively captured.

In this embodiment, as described above, the washing-capturing space 21a is formed between the spray 21b and the first receiver 21c, and structures such as a packed bed and a shelf for bringing the first cleaning liquid 11 into contact with the decarbonated combustion exhaust gas 3 while flowing down on the surface are not arranged in the washing-capturing space 21a. That is, a structure or the like in which the first cleaning liquid 11 flows down on the surface is not arranged between the spray 21b and the first receiver 21c, and the washing-capturing space 21a is formed from the spray 21b to the first receiver 21c. As a result, the washing-capturing space 21a is configured such that the first cleaning liquid 11 comes into gas-liquid contact with the decarbonated combustion exhaust gas 3 while dropping freely. The mist of the first cleaning liquid 11 sprayed from the spray 21b drops in the washing-capturing space 21a where the decarbonated combustion exhaust gas 3 rises, and directly reaches the first receiver 21c. That is, the first cleaning liquid 11 that passes through the washing-capturing space 21a is directly received by the first receiver 21c. While dropping, the first cleaning liquid 11 comes into contact with the decarbonated combustion exhaust gas 3, and the mist-like amine accompanying the decarbonated combustion exhaust gas 3 collides with the first cleaning liquid 11 and is captured.

The spray 21b sprays and drops the first cleaning liquid 11 toward the washing-capturing space 21a. The spray 21b includes a plurality of spray nozzle holes (not illustrated), and sprays the first cleaning liquid 11 supplied at an increased pressure by a first circulation pump 51 described later from the spray nozzle holes. Accordingly, the first cleaning liquid 11 is turned into a mist and is sprayed at a high speed from the spray 21b, and drops freely while being evenly distributed in the washing-capturing space 21a. That is, the spray 21b applies a first vertical initial velocity as a vertical velocity component to the first cleaning liquid 11, so as to forcibly drop (spray) freely with the vertical velocity component in the washing-capturing space 21a.

The first receiver 21c is configured to receive and store the first cleaning liquid 11 which drops in the washing-capturing space 21a and to allow the decarbonated combustion exhaust gas 3 which is discharged from the carbon dioxide capturer 20a and rises to pass therethrough. That is, the first receiver 21c includes a receiver body which receives and stores the first cleaning liquid 11, an opening which is arranged between the receiver bodies and allows the decarbonated combustion exhaust gas 3 to pass therethrough, and a cover which covers the opening from above and suppresses the first cleaning liquid 11 from passing through the opening.

A first circulation line 50 which circulates the first cleaning liquid 11 is connected to the first washer 21. That is, the first circulation pump 51 is arranged in the first circulation line 50, and extracts the first cleaning liquid 11 stored in the first receiver 21c and supplies the first cleaning liquid to the spray 21b. In this way, the first cleaning liquid 11 circulates.

The cleaning liquid mist capturer 60 captures the mist of the first cleaning liquid 11 accompanying the decarbonated combustion exhaust gas 3 discharged from the first washer 21. The cleaning liquid mist capturer 60 is arranged above the spray 21b and below a washer exit demister 82 described later.

The cleaning liquid mist capturer 60 may be configured as a countercurrent gas-liquid contact device. As an example, the cleaning liquid mist capturer 60 includes a mist capture packed bed 60a. The mist capture packed bed 60a is configured by an internal structure such as packing or particles filled inside to increase the gas-liquid contact area. A mist of the first cleaning liquid 11 accompanying the decarbonated combustion exhaust gas 3 discharged from the first washer 21 is brought into contact with and adhered to the surface of the internal structure. Accordingly, the mist of the first cleaning liquid 11 is captured (or removed) from the decarbonated combustion exhaust gas 3.

Incidentally, a capturer exit demister 81 is arranged above the carbon dioxide capturer 20a. The capturer exit demister 81 is arranged between the carbon dioxide capturer 20a and the first washer 21 (more specifically, between the liquid diffuser 20b and the first receiver 21c). As a result, the decarbonated combustion exhaust gas 3 discharged from the carbon dioxide capturer 20a passes through the capturer exit demister 81 and rises. The capturer exit demister 81 traps the mist accompanying the passing decarbonated combustion exhaust gas 3. The capturer exit demister 81 can effectively trap the mist-like amine.

The washer exit demister 82 is arranged above the cleaning liquid mist capturer 60. The washer exit demister 82 is arranged above the cleaning liquid mist capturer 60 (more specifically, between the cleaning liquid mist capturer 60 and the top of the absorption column container 20c). As a result, the decarbonated combustion exhaust gas 3 discharged from the cleaning liquid mist capturer 60 passes through the washer exit demister 82 and rises. The washer exit demister 82 traps the mist accompanying the passing decarbonated combustion exhaust gas 3. The washer exit demister 82 can effectively trap the mist-like amine and the mist of the first cleaning liquid 11, and can also trap the gaseous amine by the adhered first cleaning liquid 11.

In this embodiment, the mist capture packed bed 60a of the cleaning liquid mist capturer 60 may be configured so that the pressure loss generated in the flow of the decarbonated combustion exhaust gas 3 passing through the mist capture packed bed 60a can be lower than the pressure loss generated in the flow in the washer exit demister 82 described below. For example, the porosity (or specific surface area) of the mist capture packed bed 60a may be larger than the porosity of the washer exit demister 82. That is, as described later, the mist capture packed bed 60a aims to trap the mist of the first cleaning liquid 11 having a relatively large particle size. On the other hand, the washer exit demister 82 aims to trap the mist-like amine accompanying the decarbonated combustion exhaust gas 3, but the mist-like amine has a relatively small particle size. Consequently, in order to reduce the pressure loss, the porosity of the mist capture packed bed 60a may be larger than the porosity of the washer exit demister 82, and the mist of the first cleaning liquid 11 can be effectively trapped. In this case, a vertical length L1 of the mist capture packed bed 60a may be larger than a vertical length L2 of the washer exit demister 82. As a result, it is possible to secure an area for adhering the mist of the first cleaning liquid 11 to the internal structure.

On the other hand, the vertical length L1 of the mist capture packed bed 60a may be smaller than a vertical length L3 of the carbon dioxide capture packed bed 20d of the carbon dioxide capturer 20a. In this case, the porosity (or specific surface area) of the mist capture packed bed 60a may be equal to the porosity (or specific surface area) of the carbon dioxide capture packed bed 20d. Here, the carbon dioxide capture packed bed 20d aims to cause the carbon dioxide accompanying the combustion exhaust gas 2 to be absorbed into the lean liquid 5. For this reason, in order to secure the gas-liquid contact area, the vertical length L3 of the carbon dioxide capture packed bed 20d becomes longer. For example, in order to capture about 90% of the carbon dioxide accompanying the combustion exhaust gas 2, the vertical length L3 of the carbon dioxide capture packed bed 20d becomes longer. On the other hand, the purpose of the mist capture packed bed 60a of the cleaning liquid mist capturer 60 is to cause the mist of the first cleaning liquid 11 to physically collide with and adhere to the internal structure, and is different from that of carbon dioxide capture packed bed 20d. For this reason, the vertical length L1 of the mist capture packed bed 60a is different from the vertical length L3 of the carbon dioxide capture packed bed 20d, and may be smaller than the vertical length L3 of the carbon dioxide capture packed bed 20d.

For example, the vertical length L3 of the carbon dioxide capture packed bed 20d is 10 m to 30 m. Further, the vertical length L2 of the washer exit demister 82 is generally 10 cm to 30 cm. Therefore, the vertical length L1 of the mist capture packed bed 60a may be, for example, 50 cm to 200 cm, or may be about 100 cm.

As illustrated in FIG. 1, the regeneration column 30 includes the regeneration column washer 37 which washes the carbon dioxide-containing gas 8 discharged from the above-described amine regenerator 30a with the condensed water 9 and captures the amine accompanying the carbon dioxide-containing gas 8. The regeneration column washer 37 is arranged above the amine regenerator 30a.

The regeneration column washer 37 includes a regeneration column capturer 37a and a liquid diffuser 37b arranged above the regeneration column capturer 37a.

The regeneration column capturer 37a is configured as a countercurrent gas-liquid contact device. As an example, the regeneration column capturer 37a includes a regeneration column capture packed bed 37d. The regeneration column capture packed bed 37d is configured by an internal structure such as packing or particles filled inside to increase the gas-liquid contact area. The condensed water 9 is brought into gas-liquid contact with the carbon dioxide-containing gas 8 while flowing down on the surface of the internal structure, so as to capture (or remove) the amine from the carbon dioxide-containing gas 8.

The liquid diffuser 37b is configured to diffuse and drop the condensed water 9 toward the regeneration column capturer 37a. The condensed water 9 is supplied to the surface of the internal structure of the regeneration column capture packed bed 37d. The pressure of the condensed water 9 supplied to the liquid diffuser 37b is a pressure that is not so high as compared with the inner pressure of the regeneration column 30, and the liquid diffuser 37b drops the condensed water 9 to the regeneration column capture packed bed 37d substantially by the action of gravity rather than force.

Incidentally, the first regeneration column demister 86 is arranged above the amine regenerator 30a of the regeneration column 30. The first regeneration column demister 86 is arranged between the amine regenerator 30a and the regeneration column washer 37 (more specifically, between the liquid diffuser 30b and the regeneration column capturer 37a). As a result, the carbon dioxide-containing gas 8 discharged from the amine regenerator 30a passes through the first regeneration column demister 86 and rises. The first regeneration column demister 86 traps the mist accompanying the passing carbon dioxide-containing gas 8. The first regeneration column demister 86 can effectively trap the mist-like amine.

The second regeneration column demister 87 is arranged above the regeneration column washer 37. The second regeneration column demister 87 is arranged above the liquid diffuser 37b of the regeneration column washer 37 (more specifically, between the liquid diffuser 37b and the top of the regeneration column container 30c). As a result, the carbon dioxide-containing gas 8 discharged from the regeneration column washer 37 passes through the second regeneration column demister 87 and rises. The second regeneration column demister 87 traps the mist accompanying the passing carbon dioxide-containing gas 8. The second regeneration column demister 87 can effectively trap the mist-like amine and the mist of the condensed water 9, and can also trap the gaseous amine by the adhered condensed water 9.

Next, an action of this embodiment having such a configuration, that is, an operation method of the carbon dioxide capture system will be described.

During the operation of the carbon dioxide capture system illustrated in FIG. 1, in the carbon dioxide capture packed bed 20d of the carbon dioxide capturer 20a of the absorption column 20, the lean liquid 5 supplied from the lean liquid cooler 35 is diffused and drops from the liquid diffuser 20b and comes into gas-liquid contact with the combustion exhaust gas 2 while flowing down on the surface of the internal structure of the carbon dioxide capture packed bed 20d. The carbon dioxide contained in the combustion exhaust gas 2 is absorbed into the lean liquid 5. The combustion exhaust gas 2 is discharged from the carbon dioxide capturer 20a as the decarbonated combustion exhaust gas 3. The discharged decarbonated combustion exhaust gas 3 rises in the absorption column container 20c and passes through the capturer exit demister 81. At this time, the mist-like amine or the like accompanying the decarbonated combustion exhaust gas 3 is trapped by the capturer exit demister 81.

The decarbonated combustion exhaust gas 3 that passes through the capturer exit demister 81 passes through the first receiver 21c of the first washer 21 and reaches the washing-capturing space 21a.

On the other hand, the first cleaning liquid 11 stored in the first receiver 21c is extracted from the first receiver 21c by the first circulation pump 51, and is supplied to the spray 21b through the first circulation line 50. The pressure of the first cleaning liquid 11 supplied to the spray 21b is increased by the first circulation pump 51.

The first cleaning liquid 11 is sprayed from the spray nozzle hole of the spray 21b, drops in the washing-capturing space 21a, and directly reaches the first receiver 21c. During this time, the first cleaning liquid 11 comes into gas-liquid contact with the decarbonated combustion exhaust gas 3 while dropping in a mist state, and the decarbonated combustion exhaust gas 3 is washed with the first cleaning liquid 11. As a result, the mist-like amine accompanying the decarbonated combustion exhaust gas 3 is effectively captured in the first cleaning liquid 11. The first cleaning liquid 11 which reaches the first receiver 21c is received and stored in the first receiver 21c.

Here, a general problem occurring when the decarbonated combustion exhaust gas 3 is washed in the carbon dioxide capture system 1 will be described.

In general, in the carbon dioxide capture system 1, in order to capture the amine accompanying the decarbonated combustion exhaust gas 3, a packed bed or a shelf for a cleaning liquid flowing down on the surface is provided in some cases. In this case, the contact area between the decarbonated combustion exhaust gas 3 and the cleaning liquid increases, and the amine can be effectively captured.

The amine accompanying the decarbonated combustion exhaust gas 3 is roughly classified into the gaseous amine and the mist-like amine. Among them, the gaseous amine is easily captured by washing using a cleaning liquid and a packed bed. On the other hand, the mist-like amine is hardly captured by washing using a cleaning liquid and a packed bed. The mist-like amine is easily trapped by the demister. However, when the particle size of the mist is 5 μm or less, it is difficult to trap the mist-like amine by the demister. In order to improve the removal rate of the mist-like amine having a particle size of 5 μm or less, it is conceivable to use a high-density demister. However, the high-density demister may increase the pressure loss generated in the flow of the decarbonated combustion exhaust gas 3 passing therethrough. In this case, the power of the blower that supplies the combustion exhaust gas 2 to the absorption column 20 is increased, and the operating cost is increased. Further, in a case where a high-density demister is used, a problem that clogging of the demister may occur is also considered.

In this regard, in this embodiment, the removal rate (capture efficiency) of the mist-like amine is improved by turning the cleaning liquid into a mist. That is, in this embodiment, the pressure of the first cleaning liquid 11 supplied to the spray 21b of the first washer 21 is increased, and the first cleaning liquid 11 is sprayed from the spray nozzle hole of the spray 21b (particularly immediately after the injection) at high speed. As a result, the mist of the first cleaning liquid 11 physically collides with the mist-like amine accompanying the decarbonated combustion exhaust gas 3, and the mist-like amine is trapped by the mist of the first cleaning liquid 11. The first cleaning liquid 11 capturing the mist-like amine drops into the first receiver 21c. In this way, the mist-like amine that is hardly trapped in cleaning using a cleaning liquid, a packed bed, or the like, is captured into the first cleaning liquid 11, and the decarbonated combustion exhaust gas 3 is washed effectively. Further, it is possible to avoid the problem of pressure loss that occurs at the time of using a high-density demister as described above.

In this embodiment, the first cleaning liquid 11 with increased pressure is supplied to the spray 21b of the first washer 21, and the first cleaning liquid 11 is sprayed from the spray 21b. As a result, a mist of the first cleaning liquid 11 can be formed, and the washing efficiency of the first washer 21 can be improved. For example, when the mist of the first cleaning liquid 11 is formed using ultrasonic vibration energy, the first cleaning liquid 11 becomes in a finely atomized spray state, and a sufficient velocity component in the vertical direction may be difficult to be given to the mist of the first cleaning liquid 11. Further, when ultrasonic vibration energy is used, the pressure of the first cleaning liquid 11 is 0.1 MPa or less as described later. Thus, also in this point, a sufficient velocity component in the vertical direction may be difficult to be given to the mist of the first cleaning liquid 11. On the other hand, in this embodiment, as described later, the pressure of the first cleaning liquid 11 supplied to the spray 21b is increased to, for example, 0.1 MPa to 1.0 MPa. Thus, the first cleaning liquid 11 can be sprayed at high speed to be turned into a mist, and the washing efficiency of the first washer 21 can be improved.

As described above, the first cleaning liquid 11 sprayed from the spray 21b drops freely in the washing-capturing space 21a which is not provided with the packed bed or the like, without contacting the surface of the structure or the like. In this case, the mist of the first cleaning liquid 11 directly reaches the first receiver 21c without colliding with a member such as a structure, and thus, the mist of the first cleaning liquid 11 can be suppressed from being made fine.

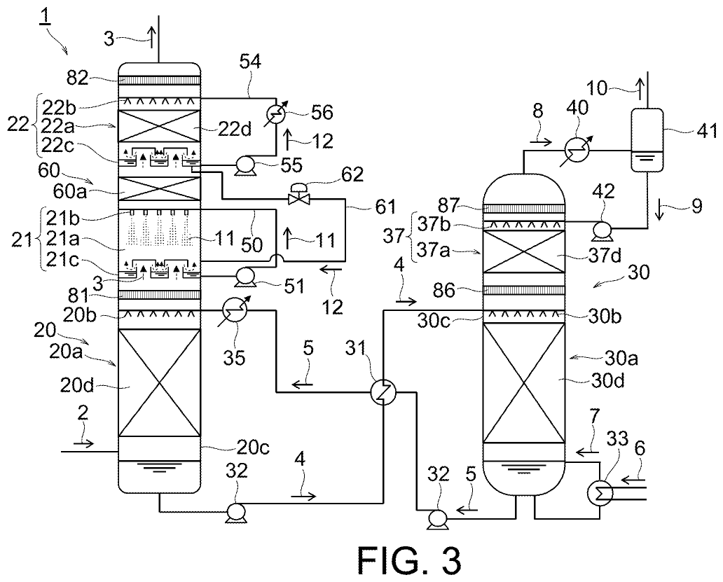

That is, in a case where a capturer (a washing capturer 22a illustrated in FIG. 3 described later) configured by a packed bed or the like is included similarly to the first washer 21 or a second washer 22, the mist of the first cleaning liquid 11 sprayed at high speed from the spray 21b collides with the packed bed and the like to be made fine. In this case, the particle size of the mist of the first cleaning liquid 11 becomes small, and the mist easily flows back along with the decarbonated combustion exhaust gas 3. For this reason, the first cleaning liquid 11 capturing the amine is released into the atmosphere along with the decarbonated combustion exhaust gas 3, and the amount of the amine released into the atmosphere may increase, which is problematic.

However, in this embodiment, the washing-capturing space 21a is formed below the spray 21b, and no member such as a structure such as a packed bed is provided. For this reason, the mist of the first cleaning liquid 11 can be suppressed from being made fine, and the decrease in the washing efficiency of the first washer 21 can be suppressed. For example, by setting the distance from the spray 21b to the first receiver 21c to at least 1 m or more, preferably 1.5 m or more, a sufficient washing-capturing space 21a can be provided. In this case, when the mist of the first cleaning liquid 11 reaches the first receiver 21c, the speed can be reduced, and it is possible to suppress that the mist collides with the first receiver 21c to be made fine. Further, in order to suppress that the sprayed mist of the first cleaning liquid 11 accompanies the decarbonated combustion exhaust gas 3, the distance from the spray 21b to the first receiver 21c may be set to 5 m or less.

Further, in a case where the first cleaning liquid 11 is sprayed at a high speed from the spray 21b of the first washer 21, there is a concern that a part of the mist of the first cleaning liquid 11 may flow backward along with the decarbonated combustion exhaust gas 3. In this case, the amine accompanies the mist of the first cleaning liquid 11, and thus the amine can be released to the atmosphere. Such a mist of the first cleaning liquid 11 accompanied by the amine can be trapped by the washer exit demister 82. However, the mist of the first cleaning liquid 11 has a larger particle size than the mist-like amine accompanying the decarbonated combustion exhaust gas 3, and the particle size of the mist of the first cleaning liquid 11 is, for example, 100 μm or more. The washer exit demister 82 aims to trap the mist-like amine accompanying the decarbonated combustion exhaust gas 3. Since the particle size of the mist-like amine is smaller than the particle size of the mist of the first cleaning liquid 11, the washer exit demister 82 is configured by a fine-grained demister. Therefore, in a case where most of the mist of the first cleaning liquid 11 is trapped by the washer exit demister 82, it is conceivable that the washer exit demister 82 is clogged.

On the other hand, in this embodiment, the cleaning liquid mist capturer 60 is arranged above the spray 21b of the first washer 21 and below the washer exit demister 82. In the cleaning liquid mist capturer 60, the mist of the first cleaning liquid 11 flowing backward along with the decarbonated combustion exhaust gas 3 can be captured. As a result, it is possible to suppress that the mist of the first cleaning liquid 11 accompanied by the amine is discharged to the atmosphere. Further, it is possible to suppress that the washer exit demister 82 is clogged. Further, in a case where the porosity of the mist capture packed bed 60a is larger than the porosity of the washer exit demister 82, the pressure loss generated in the flow of the decarbonated combustion exhaust gas 3 can be reduced.

As illustrated in FIG. 1, the decarbonated combustion exhaust gas 3 washed with the first cleaning liquid 11 is discharged from the washing-capturing space 21a of the first washer 21. Then, the decarbonated combustion exhaust gas 3 further rises in the absorption column container 20c and passes through the washer exit demister 82. At this time, the mist-like amine and the mist of the first cleaning liquid 11 accompanying the decarbonated combustion exhaust gas 3 are trapped by the washer exit demister 82.

The decarbonated combustion exhaust gas 3 that passes through the washer exit demister 82 is released to the atmosphere from the top of the absorption column container 20c.

As described above, according to this embodiment, the decarbonated combustion exhaust gas 3 discharged from the carbon dioxide capturer 20a is washed with the first cleaning liquid 11 sprayed by the spray 21b of the first washer 21, and the amine accompanying the decarbonated combustion exhaust gas 3 is captured. As a result, the first cleaning liquid 11 can be turned into a mist, and the mist of the first cleaning liquid 11 can collides physically with the mist-like amine accompanying the decarbonated combustion exhaust gas 3 discharged from the carbon dioxide capturer 20a. Therefore, the mist-like amine can be effectively captured into the first cleaning liquid 11, and the washing efficiency of the decarbonated combustion exhaust gas 3 can be improved. As a result, the amount of amine released into the atmosphere can be reduced.

Further, according to this embodiment, the mist of the first cleaning liquid 11 accompanying the decarbonated combustion exhaust gas 3 discharged from the first washer 21 is captured by the cleaning liquid mist capturer 60. As a result, the mist of the first cleaning liquid 11 flowing backward along with the decarbonated combustion exhaust gas 3 can be captured effectively. Therefore, it is possible to suppress that the mist of the first cleaning liquid 11 accompanied by the amine is released to the atmosphere. As a result, the amount of amine released into the atmosphere can be reduced.

According to this embodiment, the amine accompanying the decarbonated combustion exhaust gas 3 discharged from the cleaning liquid mist capturer 60 is trapped by the washer exit demister 82. As a result, the mist of the first cleaning liquid 11 and the mist-like amine not captured by the cleaning liquid mist capturer 60 can be captured by the washer exit demister 82. As a result, the amount of amine released into the atmosphere can be further reduced.

According to this embodiment, the vertical length L1 of the cleaning liquid mist capturer 60 is smaller than the vertical length L3 of the carbon dioxide capturer 20a. As a result, it is possible to suppress the occurrence of pressure loss in the flow of the decarbonated combustion exhaust gas 3 passing through the cleaning liquid mist capturer 60. In this case, it is possible to suppress an increase in the power of the blower that supplies the combustion exhaust gas 2 to the absorption column 20 and to suppress an increase in operating cost.

Further, according to this embodiment, the washing-capturing space 21a in which the first cleaning liquid 11 comes into gas-liquid contact with the decarbonated combustion exhaust gas 3 while freely dropping in a mist state is formed from the spray 21b of the first washer 21 to the first receiver 21c. As a result, it is possible to suppress that the mist of the first cleaning liquid 11 sprayed from the spray 21b collides with a member such as a structure before reaching the first receiver 21c. For this reason, it is possible to suppress that the mist of the first cleaning liquid 11 is made fine to accompany the decarbonated combustion exhaust gas 3.

Incidentally, in the above-described embodiment, an example has been described in which the carbon dioxide capturer 20a includes the carbon dioxide capture packed bed 20d. However, the present invention is not limited to this, and the carbon dioxide capturer 20a may be configured by a shelf (not illustrated). The same applies to the amine regenerator 30a and the regeneration column capturer 37a.

### Second Embodiment

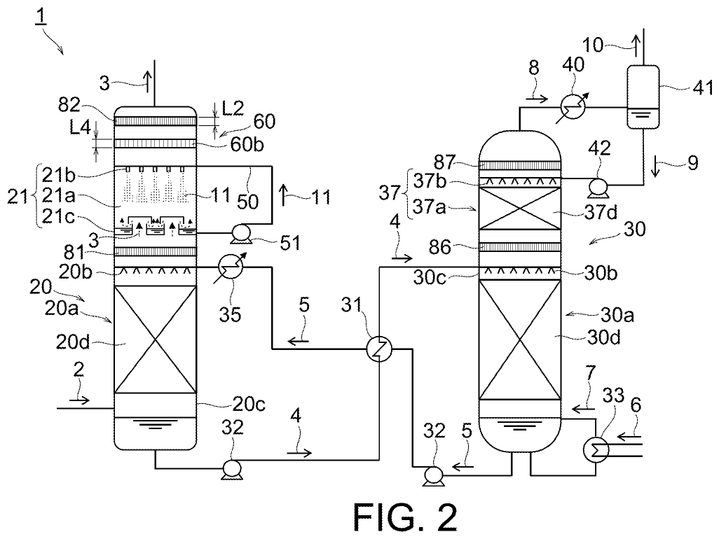

Next, a carbon dioxide capture system and a method of operating the carbon dioxide capture system according to a second embodiment of the present invention will be described with reference to FIG. 2.

The second embodiment illustrated in FIG. 2 is different mainly in that the cleaning liquid mist capturer is formed more sparsely than the washer exit demister. The other configuration is substantially the same as that of the first embodiment illustrated in FIG. 1. Incidentally, in FIG. 2, the same parts as those in the first embodiment illustrated in FIG. 1 are denoted by the same reference numerals, and detailed description will be omitted.

In this embodiment, as illustrated in FIG. 2, the cleaning liquid mist capturer 60 includes a mist capture demister 60b instead of the above-described mist capture packed bed 60a. The mist capture demister 60b may be formed in a mesh shape. The washer exit demister 82 described above may also be formed in a mesh shape.

The mist capture demister 60b of the cleaning liquid mist capturer 60 may be configured so that the pressure loss generated in the flow of the decarbonated combustion exhaust gas 3 passing through the mist capture demister 60b can be lower than the pressure loss generated in the flow in the washer exit demister 82. In this embodiment, the mist capture demister 60b is formed more sparsely than the washer exit demister 82.

The fact that the demister is formed sparsely or densely can be explained, for example, on the basis of the porosity of the demister. More specifically, the magnitude of the porosity of the demister may correspond to the sparseness or denseness of the demister. In this case, the fact that the mist capture demister 60b is formed more sparsely than the washer exit demister 82 means that the porosity of the mist capture demister 60b is larger than the porosity of the washer exit demister 82. As a result, the space of the mist capture demister 60b through which the decarbonated combustion exhaust gas 3 passes increases, and the decarbonated combustion exhaust gas 3 easily passes therethrough. For this reason, the pressure loss generated in the flow of the decarbonated combustion exhaust gas 3 can be reduced. For example, in a case where the mist capture demister 60b and the washer exit demister 82 are mesh-like demisters, the mesh of the mist capture demister 60b may be coarser than the mesh of the washer exit demister 82.

The fact that the demister is formed sparsely or densely can also be explained, for example, on the basis of the mist removal (or capture) rate characteristics of the demister. More specifically, when the characteristics of the demister are indicated by the mist removal rate in a predetermined particle size range (for example, 0.1 μm to 10 μm), the magnitude of the removal rate may be made to correspond to the sparseness or denseness of the dense demister. In this case, the fact that the mist capture demister 60b is formed more sparsely than the washer exit demister 82 means that the removal rate of the mist in the predetermined particle size range in the mist capture demister 60b is smaller than the removal rate of the washer exit demister 82.

The mist capture demister 60b according to this embodiment aims to remove the mist of the first cleaning liquid 11 having a relatively large particle size (for example, a particle size of 100 μm or more), and thus, as described above, the mist capture demister 60b is formed more sparsely than the washer exit demister 82. As a result, the mist capture demister 60b can be configured by a demister coarser than the washer exit demister 82, thereby suppressing an increase in pressure loss and suppressing clogging. On the other hand, the washer exit demister 82 can be configured by a fine-grained demister and can effectively trap the mist-like amine that cannot be trapped by the first washer 21.

Note that a vertical length L4 of the mist capture demister 60b in this embodiment may be equal to the vertical length L2 of the washer exit demister 82.

As described above, according to this embodiment, the cleaning liquid mist capturer 60 is formed more sparsely than the washer exit demister 82. As a result, while the mist-like amine and the mist of the first cleaning liquid 11 are trapped by the washer exit demister 82, the pressure loss generated in the flow of the decarbonated combustion exhaust gas 3 passing through the washer exit demister 82 can be reduced. In this case, the power of the blower B for supplying the combustion exhaust gas 2 to the absorption column 20 can be reduced, and the operating cost can be reduced.

### Third Embodiment

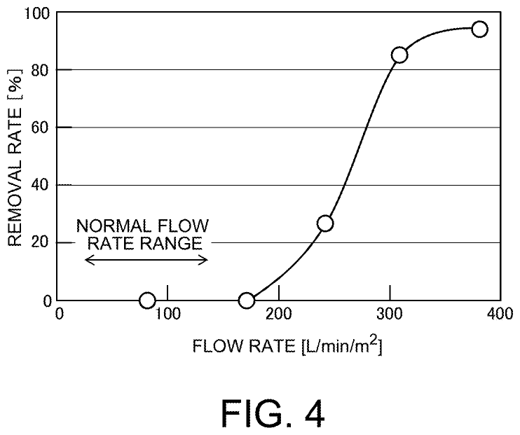

Next, a carbon dioxide capture system and a method of operating the carbon dioxide capture system according to a third embodiment of the present invention will be described with reference to FIGS. 3 and 4.

The third embodiment shown in FIGS. 3 and 4 is different mainly in that the second washer is provided which washes the combustion exhaust gas discharged from the first washer with a second cleaning liquid diffused and dropped by a cleaning liquid diffuser, and captures the amine accompanying the combustion exhaust gas. The other configuration is substantially the same as that of the first embodiment illustrated in FIG. 1. Incidentally, in FIGS. 3 and 4, the same parts as those in the first embodiment illustrated in FIG. 1 are denoted by the same reference numerals, and detailed description will be omitted.

In this embodiment, as illustrated in FIG. 3, the first cleaning liquid 11 at the first pressure is supplied to the spray 21b of the first washer 21. That is, the pressure of the first cleaning liquid 11 supplied to the spray 21b is increased by the first circulation pump 51 so as to be the first pressure. The first cleaning liquid 11 supplied at the first pressure is sprayed from the spray 21b into the washing-capturing space 21a. The first pressure is higher than the pressure (second pressure) of the second cleaning liquid 12 supplied to a cleaning liquid diffuser 22b of the second washer 22 to be described later.

In this embodiment, as illustrated in FIG. 3, the second washer 22 is arranged in the absorption column 20. The second washer 22 washes the decarbonated combustion exhaust gas 3 discharged from the cleaning liquid mist capturer 60 with the second cleaning liquid 12 (second washing water), and captures the amine accompanying the decarbonated combustion exhaust gas 3. The second washer 22 is arranged above the cleaning liquid mist capturer 60 and below the washer exit demister 82.

The second washer 22 includes a washing capturer 22a, a cleaning liquid diffuser 22b arranged above the washing capturer 22a, and a second receiver 22c arranged below the washing capturer 22a.

The washing capturer 22a is configured as a countercurrent gas-liquid contact device. As an example, the washing capturer 22a includes a washing capture packed bed 22d. The washing capture packed bed 22d is formed of an internal structure such as packing or particles filled inside to increase the gas-liquid contact area. The second cleaning liquid 12 is brought into gas-liquid contact with the decarbonated combustion exhaust gas 3 while flowing down on the surface of the internal structure, so as to capture (or remove) the amine accompanying the decarbonated combustion exhaust gas 3. In the second washer 22, the gaseous amine can be effectively captured, and the mist-like amine can also be effectively captured.

The cleaning liquid diffuser 22b is configured to diffuse and drop the second cleaning liquid 12 supplied at the second pressure toward the washing capturer 22a. The second cleaning liquid 12 is supplied so as to flow down on the surface of the internal structure of the washing capturer 22a. The second pressure is lower than the first pressure which is the pressure of the first cleaning liquid 11 supplied to the spray 21b of the first washer 21. The pressure (second pressure) of the second cleaning liquid 12 supplied to the cleaning liquid diffuser 22b is not so high as the pressure in the absorption column 20. The second vertical initial velocity, which is a vertical velocity component applied to the second cleaning liquid 12 to be diffused by the cleaning liquid diffuser 22b, is smaller than the first vertical initial velocity which is a vertical velocity component which the spray 21b of the first washer 21 gives to the first cleaning liquid 11. The second vertical initial velocity, which is the vertical velocity component applied to the second cleaning liquid 12, is substantially zero, and the cleaning liquid diffuser 22b causes the second cleaning liquid 12 to drop freely in the washing capturer 22a non-compulsively by the action of gravity.

The second receiver 22c is configured to receive and store the second cleaning liquid 12 which flows down on the surface of the internal structure of the washing capturer 22a and to allow and the decarbonated combustion exhaust gas 3 which is discharged from the washing-capturing space 21a of the first washer 21 and rises to pass therethrough. The second receiver 22c is configured similarly to the first receiver 21c.

A second circulation line 54 which circulates the second cleaning liquid 12 is connected to the second washer 22. That is, a second circulation pump 55 is arranged in the second circulation line 54, and extracts the second cleaning liquid 12 stored in the second receiver 22c and supplies the second cleaning liquid 12 to the cleaning liquid diffuser 22b. In this way, the second cleaning liquid 12 is circulated.

In this embodiment, a second cleaning liquid cooler 56 which cools the second cleaning liquid 12 is arranged in the second circulation line 54. The second cleaning liquid cooler 56 is supplied with a cooling medium (for example, cooling water of or seawater) from the outside of the carbon dioxide capture system 1 as a cooling medium for cooling the second cleaning liquid 12. In this way, the second cleaning liquid cooler 56 is configured to cool the second cleaning liquid 12 flowing through the second circulation line 54, and the temperature of the second cleaning liquid 12 is lower than the temperature of the first cleaning liquid 11. Incidentally, the temperature of the second cleaning liquid 12 and the temperature of the first cleaning liquid 11 may be configured to be substantially equal.

Incidentally, the flow rate (first flow rate) per unit area and unit time of the first cleaning liquid 11 sprayed from the spray 21b of the first washer 21 is larger than the flow rate (second flow rate) per unit area and unit time of the second cleaning liquid 12 diffused from the cleaning liquid diffuser 22b of the second washer 22. The flow rate of the first cleaning liquid 11 sprayed from the spray 21b is adjusted by the above-described first circulation pump 51 (flow rate adjusting unit). Similarly, the flow rate of the second cleaning liquid 12 diffused from the cleaning liquid diffuser 22b is adjusted by the above-described second circulation pump 55.

Incidentally, the unit area described here is a unit area with respect to the horizontal cross-sectional area where the spray 21b sprays the first cleaning liquid 11 (or the horizontal cross-sectional area of the first washer 21) and the horizontal cross-sectional area where the cleaning liquid diffuser 22b diffuses the second cleaning liquid 12 (or the horizontal cross-sectional area of the second washer 22). In this embodiment, the horizontal cross-sectional areas of the first washer 21 and the second washer 22 are substantially equal, and thus the first flow rate and the second flow rate may be set on the basis of the flow rate per unit time without consideration of the difference between the horizontal cross-sectional areas of the washers (the first washer 21 and the second washer 22).

When generalization is made to include a case where the horizontal cross-sectional areas of the washers 21 and 22 are different, for example, the flow rate (first flow rate) per unit area and unit time of the first cleaning liquid 11 sprayed from the spray 21b may be 200 L/min/m² or more or may be 300 L/min/m² or more. The flow rate (second flow rate) per unit area and unit time of the second cleaning liquid 12 diffused from the cleaning liquid diffuser 22b may be 50 L/min/m² to 150 L/min/m² (the normal flow rate range illustrated in FIG. 4).

The second cleaning liquid 12 diffused from the cleaning liquid diffuser 22b comes into gas-liquid contact with the decarbonated combustion exhaust gas 3 while flowing down on the surface of the internal structure forming the washing capture packed bed 22d. Therefore, even if the flow rate of the second cleaning liquid 12 per unit area and unit time is larger than 150 L/min/m², the contribution to the improvement of the washing efficiency of the decarbonated combustion exhaust gas 3 is limited. Further, increasing the flow rate of the second cleaning liquid 12 more than necessary increases the capacity of the second circulation pump 55 and increases the operating cost, which is not preferable. However, in the first washer 21, the first cleaning liquid 11 sprayed from the spray 21b is brought into gas-liquid contact with the decarbonated combustion exhaust gas 3 in a mist state without providing a member such as a packed bed. As a result, increasing the flow rate per unit area and unit time of the first cleaning liquid 11 can contribute to increasing the probability of physical collision with the mist-like amine accompanying the decarbonated combustion exhaust gas 3 and can improve the washing efficiency of the decarbonated combustion exhaust gas 3. This is illustrated in FIG. 4.

FIG. 4 is a graph illustrating a relationship between the flow rate of the first cleaning liquid 11 and the mist-like amine removal rate (capture efficiency). This data is obtained under the following test conditions.
Inner diameter of test device (corresponding to the inner diameter of the part where the first washer 21 is arranged in the absorption column container 20c) . . . 157 mm
Flow rate of treatment gas (corresponding to the flow rate of the decarbonated combustion exhaust gas 3) . . . 0.7 m/s
Concentration of mist-like amine droplets (particle size 0.61 μm to 0.95 μm) . . . about 10,000/cc
Mean particle size of cleaning liquid mist: about 300 μm
First pressure . . . 0.2 MPa

As illustrated in FIG. 4, the removal rate of the mist-like amine is low in the normal flow rate range of the second cleaning liquid 12, but the removal rate increases beyond this range. When the flow rate is 300 L/min/m² or more, the removal rate exceeds 70%, and the removal rate of mist-like amine can be increased.

As described above, the first pressure (pressure in the spray 21b) of the first cleaning liquid 11 supplied to the spray 21b of the first washer 21 is higher than the second pressure (the pressure in the cleaning liquid diffuser 22b) of the second cleaning liquid 12 supplied to the cleaning liquid diffuser 22b of the second washer 22. The first pressure of the first cleaning liquid 11 supplied to the spray 21b is adjusted by the above-described first circulation pump 51 (pressure adjusting unit). Similarly, the second pressure of the second cleaning liquid 12 supplied to the cleaning liquid diffuser 22b is adjusted by the above-described second circulation pump 55. For example, the first pressure of the first cleaning liquid 11 supplied to the spray 21b may be 0.1 MPa to 1.0 MPa. By setting the first pressure of the first cleaning liquid 11 to 0.1 MPa or more, the mist spray speed of the first cleaning liquid 11 can be increased, and the washing efficiency of the first washer 21 can be improved. On the other hand, by setting the first pressure of the first cleaning liquid 11 to 1.0 MPa or less, the particle size of the mist of the sprayed first cleaning liquid 11 can be suppressed from becoming broad (having a wide particle size distribution), and washing performance can be stabilized. Further, it is possible to suppress an increase in the capacity (required power) of the first circulation pump 51 and to suppress an increase in operating cost.

Note that the second pressure of the second cleaning liquid 12 supplied to the cleaning liquid diffuser 22b may be 0.1 MPa or less. For example, when the discharge pressures of the first circulation pump 51 and the second circulation pump 55 are set in consideration of the respective lifts (water heads) up to the spray 21b and the cleaning liquid diffuser 22b, the first pressure and the second pressure can be appropriately set as described above.

The particle size of the first cleaning liquid 11 sprayed from the spray 21b of the first washer 21 is preferably smaller. In a case where the flow rate is considered to be the same, the number of mist droplets can be increased when the particle size of the mist in the first cleaning liquid 11 is reduced. In this case, the probability of physical collision with the mist-like amine accompanying the decarbonated combustion exhaust gas 3 can be increased. For example, the mean particle size of the first cleaning liquid 11 may be 100 μm to 1000 μm, preferably 200 μm to 800 μm. Here, when the mean particle size is set to 100 μm or more, it is possible to suppress that the mist of the first cleaning liquid 11 containing the amine accompanies the flow of the decarbonated combustion exhaust gas 3 to reduce the washing efficiency of the first washer 21. In order to further suppress that the mist of the first cleaning liquid 11 accompanies the decarbonated combustion exhaust gas 3, the mean particle size of the first cleaning liquid 11 sprayed from the spray 21b may be 200 μm or more. On the other hand, when the mean particle size is set to 1000 μm or less, the mean particle size of the mist of the first cleaning liquid 11 can be reduced, and the number of mist droplets of the first cleaning liquid 11 is increased so as to increase the probability of collision with the mist-like amine accompanying the decarbonated combustion exhaust gas 3. In order to further increase the probability of collision with the mist-like amine accompanying the decarbonated combustion exhaust gas 3, the mean particle size of the first cleaning liquid 11 sprayed from the spray 21b may be 800 μm or less.

The spray nozzle hole of the above-described spray 21b is configured to be able to form a mist of the first cleaning liquid 11 having such a mean particle size. Here, the mean particle size is an average value of the particle sizes of the first cleaning liquid 11 sprayed from the spray 21b. In addition to the average value, the mean particle size may be appropriately defined by a median value or a function using variance, image standard deviation, or the like in addition to the average value and the median value.

As described above, the amine accompanying the decarbonated combustion exhaust gas 3 is roughly classified into a gaseous amine and a mist-like amine. However, generally, the mist-like amine has a higher ratio as amine amount. As a result, when the first cleaning liquid 11 for initially washing the decarbonated combustion exhaust gas 3 discharged from the carbon dioxide capturer 20a is sprayed from the spray 21b, and the mist-like amine is captured in the washing-capturing space 21a, the amine accompanying the decarbonated combustion exhaust gas 3 can be captured effectively. In this case, the amount of the amine accompanying the decarbonated combustion exhaust gas 3 supplied to the second washer 22 is reduced. Therefore, the amine concentration of the second cleaning liquid 12 is lower than the amine concentration of the first cleaning liquid 11.

Here, in order to effectively wash the gaseous amine, it is preferable to use a cleaning liquid having a low amine concentration. That is, the amine concentration of the second cleaning liquid 12 is preferably low. In order to lower the amine concentration, it is conceivable to replenish a new cleaning liquid as a new liquid to be mixed with the second cleaning liquid 12 or to increase the replenishment amount (makeup amount) of the cleaning liquid. However, in this case, the disposal amount of the cleaning liquid increases, which may lead to an increase in operating cost. Therefore, it is preferable to reduce the amine concentration of the decarbonated combustion exhaust gas 3 flowing into the second washer 22. In this case, it is possible to suppress an increase in the amine concentration of the second cleaning liquid 12. Therefore, the make-up amount of the second cleaning liquid 12 can be reduced, and the operating cost can be suppressed. Further, the amine concentration of the second cleaning liquid 12 used in the second washer 22 can be reduced, and thus the capture efficiency of amine mainly composed of gaseous amine can be increased. For this reason, it is possible to further suppress the release of the amine into the atmosphere and achieve both cost and environmental friendliness.

Incidentally, in a case where the cleaning liquid mist capturer 60 is not provided, the mist of the first cleaning liquid 11 flowing backward can be captured by the washing capturer 22a of the second washer 22. However, in this case, the mist of the first cleaning liquid 11 accompanying the amine is taken into the second cleaning liquid 12 in the second washer 22. For this reason, the amine concentration of the second cleaning liquid 12 is easily increased.

On the other hand, according to this embodiment, the cleaning liquid mist capturer 60 is arranged between the first washer 21 and the second washer 22. As a result, it is possible to suppress an increase in the amine concentration of the second cleaning liquid 12.

As illustrated in FIG. 3, the carbon dioxide capture system 1 according to this embodiment may further include a bypass line 61 for mixing a part of the second cleaning liquid 12 into the first cleaning liquid 11. FIG. 3 illustrates an example in which the upstream end (the end on the side of the second washer 22) of the bypass line 61 is connected to the second receiver 22c of the second washer 22. As a result, a part of the second cleaning liquid 12 stored in the second receiver 22c is mixed into the first cleaning liquid 11. An example is illustrated in which the downstream end (the end on the side of the first washer 21) of the bypass line 61 is disposed near the upper side of the first receiver 21c of the first washer 21. As a result, the second cleaning liquid 12 which passes through the bypass line 61 is supplied to the first receiver 21c.

The amine concentration of the first cleaning liquid 11 increases as the amine of the decarbonated combustion exhaust gas 3 is trapped. Therefore, the amine concentration of the first cleaning liquid 11 becomes higher than the amine concentration of the second cleaning liquid 12. Therefore, when the second cleaning liquid 12 is reused as the first cleaning liquid 11, the replenishment amount of the new first cleaning liquid 11 as a new liquid can be reduced. In particular, the first washer 21 according to this embodiment washes the decarbonated combustion exhaust gas 3 by spraying the first cleaning liquid 11 by the spray 21b, and thus the amine can be captured more effectively as compared to a case where the decarbonated combustion exhaust gas 3 is washed using the packed bed. Consequently, since the amine concentration of the first cleaning liquid 11 can be increased, the amine concentration of the first cleaning liquid 11 can be effectively reduced by mixing the second cleaning liquid 12 into the first cleaning liquid 11, and the deterioration of the amine capturing performance in the first washer 21 can be suppressed. Incidentally, in a case where the amine concentration of the first cleaning liquid 11 becomes high, the first cleaning liquid 11 can be reused as an absorbing liquid. In this case, the first cleaning liquid 11 may be concentrated and then reused as an absorbing liquid, or may be reused as an absorbing liquid without being concentrated.

A bypass valve 62 may be arranged in the bypass line 61. For example, the bypass valve 62 may be controlled on the basis of the liquid level of the second cleaning liquid 12 stored in the second receiver 22c. In this case, a liquid level meter (not illustrated) is arranged in the second receiver 22c. In a case where the liquid level of the second cleaning liquid 12 stored in the second receiver 22c is higher than a predetermined reference level, the bypass valve 62 may be opened or the opening of the bypass valve 62 may be increased, and in a case where the bypass valve 62 is lower than the predetermined reference level, the bypass valve 62 may be closed or the opening of the bypass valve 62 may be reduced. Further, the opening of the bypass valve 62 may be adjusted according to the liquid level of the second cleaning liquid 12.

During the operation of the carbon dioxide capture system 1 in this embodiment, the decarbonated combustion exhaust gas 3 which passes through the cleaning liquid mist capturer 60 reaches the washing capturer 22a through the second receiver 22c of the second washer 22.

On the other hand, the second cleaning liquid 12 stored in the second receiver 22c is extracted from the second receiver 22c by the second circulation pump 55, and is supplied to the cleaning liquid diffuser 22b through the second circulation line 54. During this time, the second cleaning liquid 12 is cooled by the second cleaning liquid cooler 56, and the temperature of the second cleaning liquid 12 becomes lower than the temperature of the first cleaning liquid 11.

In the washing capturer 22a, the cooled second cleaning liquid 12 comes into gas-liquid contact with the decarbonated combustion exhaust gas 3 while flowing down on the surface of the washing capturer 22a, and the decarbonated combustion exhaust gas 3 is washed. As a result, the gaseous amine and the like accompanying the decarbonated combustion exhaust gas 3 are captured in the second cleaning liquid 12. The second cleaning liquid 12 which washes the decarbonated combustion exhaust gas 3 in the washing capturer 22a drops from the washing capturer 22a and is received and is stored in the second receiver 22c.

Since the cooled second cleaning liquid 12 is supplied to the washing capturer 22a, the temperature of the washing capturer 22a becomes lower than the temperature of the washing-capturing space 21a. Therefore, the decarbonated combustion exhaust gas 3 is cooled by the second cleaning liquid 12, and the temperature of the decarbonated combustion exhaust gas 3 decreases. Due to the decrease in the temperature of the decarbonated combustion exhaust gas 3, the vapor accompanying the decarbonated combustion exhaust gas 3 is condensed, and the condensed water is trapped by the second cleaning liquid 12. As a result, the amine concentration of the second cleaning liquid 12 decreases.

The mist of the first cleaning liquid 11 not captured by the cleaning liquid mist capturer 60 is supplied to the washing capturer 22a of the second washer 22 and is cooled in the washing capturer 22a. In the washing capturer 22a, the condensed water is also trapped in the mist of the first cleaning liquid 11. As a result, the particle size of the mist of the first cleaning liquid 11 increases, and the mist of the first cleaning liquid is easily trapped by the washer exit demister 82 arranged above the washing capturer 22a.

The decarbonated combustion exhaust gas 3 washed with the second cleaning liquid 12 is discharged from the washing capturer 22a, further rises in the absorption column container 20c, and passes through the washer exit demister 82.

As described above, according to this embodiment, the second washer 22 washes the decarbonated combustion exhaust gas 3 discharged from the cleaning liquid mist capturer 60 with the second cleaning liquid 12 which is diffused and dropped by the cleaning liquid diffuser 22b to capture the amine accompanying the decarbonated combustion exhaust gas 3. As a result, the amine accompanying the decarbonated combustion exhaust gas 3 not captured by the first washer 21 can be captured in the second cleaning liquid 12. For this reason, the amount of amine released into the atmosphere can be further reduced.

According to this embodiment, the first pressure of the first cleaning liquid 11 supplied to the spray 21b of the first washer 21 is higher than the second pressure of the second cleaning liquid 12 supplied to the cleaning liquid diffuser 22b of the second washer 22. As a result, it is possible to particularly increase the first vertical initial velocity which is a vertical velocity component in the spray speed of the mist of the first cleaning liquid 11 from the spray 21b. Therefore, the mist of the first cleaning liquid 11 can be quickly and uniformly supplied into the washing-capturing space 21a, and the mist-like amine accompanying the decarbonated combustion exhaust gas 3 can be captured effectively. Further, it is possible to suppress the mist of the first cleaning liquid 11 accompanies the decarbonated combustion exhaust gas 3.

According to this embodiment, the flow rate (first flow rate) per unit area and unit time of the first cleaning liquid 11 sprayed from the spray 21b of the first washer 21 is larger than the flow rate (second flow rate) per unit area and unit time of the second cleaning liquid 12 diffused from the cleaning liquid diffuser 22b of the second washer 22. As a result, the number of mist droplets of the first cleaning liquid 11 sprayed from the spray 21b can be increased, and the probability of physical collision with the mist-like amine accompanying the decarbonated combustion exhaust gas 3 can be increased. Therefore, the mist-like amine can be more effectively captured.

According to this embodiment, a part of the second cleaning liquid 12 having an amine concentration lower than that of the first cleaning liquid 11 can be mixed into the first cleaning liquid 11 by the bypass line 61. As a result, the amine concentration of the first cleaning liquid 11 can be reduced, and the deterioration of the amine capturing performance in the first washer 21 can be suppressed. Further, since the second cleaning liquid 12 can be reused as the first cleaning liquid 11, it is unnecessary to dispose the second cleaning liquid 12, and the frequency of supplying the first cleaning liquid 11 with a new cleaning liquid can be reduced.

Incidentally, in this embodiment described above, an example is described in which the spray 21b of the first washer 21 is configured as a so-called one-fluid nozzle in which the first cleaning liquid 11 with increased pressure is sprayed from a spray nozzle hole. However, the present invention is not limited to this, and the spray 21b may be configured as a two-fluid nozzle as long as the first cleaning liquid 11 can be sprayed. In this case, as long as the first cleaning liquid 11 can be sprayed, the pressure of the first cleaning liquid 11 supplied to the spray 21b may be 0.1 MP or less.

In this embodiment described above, an example is described in which the washer exit demister 82 is arranged above the second washer 22, and the top of the absorption column container 20c is disposed above the washer exit demister 82. However, the present invention is not limited to this. For example, a third washer (not illustrated) having a configuration similar to that of the second washer 22 may be arranged above the cleaning liquid diffuser 22b of the second washer 22. In this case, the decarbonated combustion exhaust gas 3 can be further washed with a third cleaning liquid (not illustrated), and the amine accompanying the decarbonated combustion exhaust gas 3 can be further captured. For this reason, the amount of amine released into the atmosphere can be further reduced.

In the above-described embodiment, an example is described in which the washing capturer 22a includes the washing capture packed bed 22d. However, the present invention is not limited to this, and the washing capturer 22a may be configured by a shelf.

### Fourth Embodiment

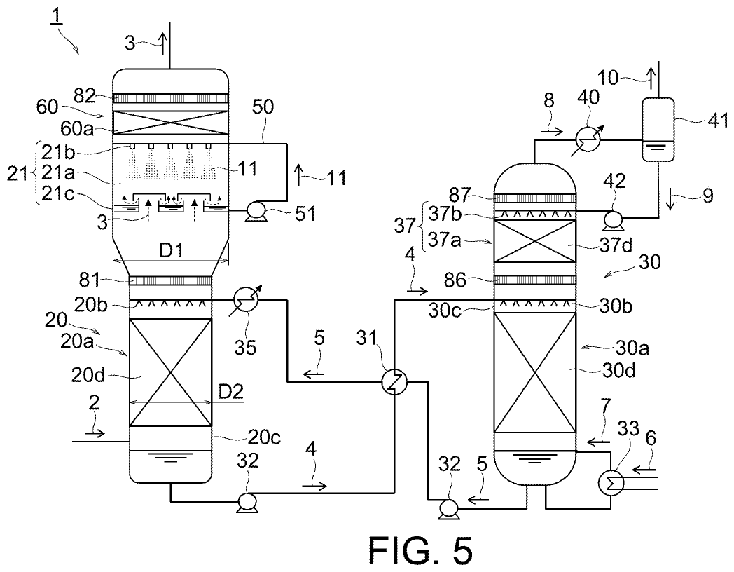

Next, a carbon dioxide capture system and a method of operating the carbon dioxide capture system according to a fourth embodiment of the present invention will be described with reference to FIG. 5.

The fourth embodiment illustrated in FIG. 5 is different mainly in that the diameter of the first washer is larger than the diameter of the carbon dioxide capturer. The other configuration is substantially the same as that of the first embodiment illustrated in FIG. 1. Incidentally, in FIG. 5, the same parts as those in the first embodiment illustrated in FIG. 1 are denoted by the same reference numerals, and detailed description will be omitted.

In this embodiment, as illustrated in FIG. 5, the carbon dioxide capturer 20a of the absorption column 20 is formed in a cylindrical shape. That is, in the absorption column container 20c of the absorption column 20, at least a portion corresponding to the carbon dioxide capturer 20a is formed in a cylindrical shape. The absorption column container 20c may be formed in a cylindrical shape with substantially the same diameter from the bottom to the portion corresponding to the capturer exit demister 81.

The first washer 21 is formed in a cylindrical shape. That is, in this embodiment, the first washer 21 is housed in the absorption column container 20c, and a portion of the absorption column container 20c corresponding to the washing-capturing space 21a of the first washer 21 is formed in a cylindrical shape. The absorption column container 20c may be formed in a cylindrical shape with substantially the same diameter from the portion corresponding to the first receiver 21c to the top.

As illustrated in FIG. 5, a diameter D1 of the washing-capturing space 21a of the first washer 21 is larger than a diameter D2 of the carbon dioxide capturer 20a. A truncated cone shaped portion is formed between the portion corresponding to the capturer exit demister 81 and the portion corresponding to the first receiver 21c in the absorption column container 20c so that the diameter gradually increases.

Here, in a case where the flow rate of the decarbonated combustion exhaust gas 3 passing through the first washer 21 is high, the amount of the mist of the first cleaning liquid 11 flowing backward along with the decarbonated combustion exhaust gas 3 may increase. For this reason, the first cleaning liquid 11 capturing the amine is released into the atmosphere along with the decarbonated combustion exhaust gas 3, and the amount of the amine released into the atmosphere may increase, which is problematic.

On the other hand, in this embodiment, the diameter D1 of the washing-capturing space 21a of the first washer 21 is larger than the diameter D2 of the carbon dioxide capturer 20a, and thus, the flow rate of the decarbonated combustion exhaust gas 3 passing through the first washer 21 can be reduced. As a result, the amount of the mist of the first cleaning liquid 11 flowing backward along with the decarbonated combustion exhaust gas 3 can be reduced.

For example, the diameter D1 of the washing-capturing space 21a may be set so as to obtain the gas flow rate of the decarbonated combustion exhaust gas 3 defined by the following inequality.

Gas flow rate [m/s]≤0.0037×Mean particle size of cleaning liquid mist [μm]

When the diameter D1 of the washing-capturing space 21a of the first washer 21 is set so as to satisfy this inequality, the amount of the mist of the first cleaning liquid 11 flowing backward along with the decarbonated combustion exhaust gas 3 can be reduced. The above formula is a formula obtained by multiplying the safety factor by an empirical rule on the basis of the terminal speed of the cleaning liquid mist. The terminal speed means a speed when the gravity received by the cleaning liquid mist and air resistance are balanced and the cleaning liquid mist drops at a constant speed.

According to this embodiment, the carbon dioxide capturer 20a and the washing-capturing space 21a of the first washer 21 are each formed in a cylindrical shape, and the diameter D1 of the washing-capturing space 21a is larger than the diameter D2 of the carbon dioxide capturer 20a. As a result, the gas flow rate of the decarbonated combustion exhaust gas 3 passing through the washing-capturing space 21a can be reduced, and the mist of the first cleaning liquid 11 accompanied by the amine can be suppressed from flowing backward along with the decarbonated combustion exhaust gas 3. For this reason, the amount of amine released into the atmosphere can be further reduced.

### Fifth Embodiment

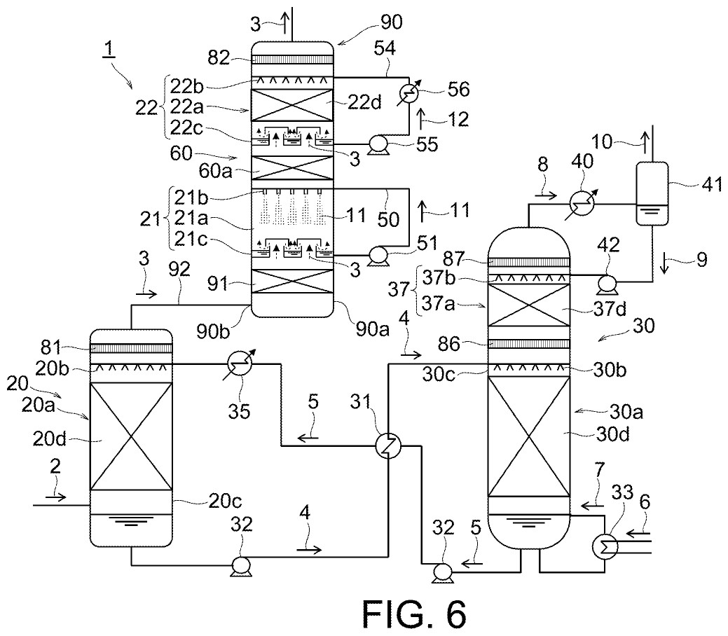

Next, a carbon dioxide capture system and a method of operating the carbon dioxide capture system according to a fifth embodiment of the present invention will be described with reference to FIG. 6.

The fifth embodiment illustrated in FIG. 6 is different mainly in that the first washer is housed in a washing column, and in the washing column, a rectifier which rectifies the flow of the combustion exhaust gas introduced into the washing column is arranged below the first washer. The other configuration is substantially the same as that of the third embodiment illustrated in FIG. 3. Incidentally, in FIG. 6, the same parts as those in the third embodiment illustrated in FIG. 3 are denoted by the same reference numerals, and detailed description will be omitted.

In this embodiment, as illustrated in FIG. 6, the carbon dioxide capturer 20a and the capturer exit demister 81 are housed in the absorption column 20. However, the first washer 21, the cleaning liquid mist capturer 60, and the second washer 22 and the washer exit demister 82 are not housed.

The carbon dioxide capture system 1 according to this embodiment further includes a washing column 90 configured separately from the absorption column 20. The washing column 90 includes a washing column container 90a, and the first washer 21, the cleaning liquid mist capturer 60, the second washer 22, and the washer exit demister 82 are housed in the washing column container 90a.

As illustrated in FIG. 6, a rectifier 91 is arranged below the first receiver 21c of the first washer 21 in the washing column container 90a. The rectifier 91 is configured to rectify the flow of the decarbonated combustion exhaust gas 3 introduced into the washing column container 90a. It is preferable that the rectifier 91 is configured to be able to suppress the pressure loss generated in the flow of the decarbonated combustion exhaust gas 3. For example, a packed bed similar to the above-described carbon dioxide capture packed bed 20d or the like can be employed as the rectifier 91.

The washing column container 90a includes a gas introduction part 90b into which the decarbonated combustion exhaust gas 3 discharged from the absorption column 20 is introduced. The gas introduction part 90b is arranged below the rectifier 91 and on the side surface of the washing column container 90a. The gas introduction part 90b is connected to the top of the absorption column container 20c of the absorption column 20 via an exhaust gas line 92.

Incidentally, in a case where the above-described rectifier 91 is not provided, it is possible that the flow of the decarbonated combustion exhaust gas 3 introduced into the washing column container 90a is biased without rectification. For example, as illustrated in FIG. 6, in a case where the gas introduction part 90b is arranged on the side surface of the washing column container 90a, the flow of the decarbonated combustion exhaust gas 3 supplied to the washing-capturing space 21a may be biased. In this case, there is a concern that the mist of the first cleaning liquid 11 sprayed from the spray 21b is unevenly distributed to reduce the washing efficiency of the first washer 21.

On the other hand, according to this embodiment, in the washing column 90, the rectifier 91 is arranged below the first washer 21, and thus the decarbonated combustion exhaust gas 3 supplied to the washing-capturing space 21a can be rectified. As a result, the mist of the first cleaning liquid 11 sprayed from the spray 21b can be suppressed from being unevenly distributed, and the mist of the first cleaning liquid 11 can be evenly distributed in the washing-capturing space 21a. Therefore, the mist-like amine can be effectively captured into the first cleaning liquid 11, and the washing efficiency of the decarbonated combustion exhaust gas 3 can be improved. As a result, the amount of amine released into the atmosphere can be reduced.

According to the above-described embodiment, the amount of amine released into the atmosphere can be reduced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Further, it will be understood that these embodiments can be at least partially combined properly without departing from the spirit of the present invention.

1. A carbon dioxide capture system comprising:
a carbon dioxide capturer configured to cause a carbon dioxide contained in a combustion exhaust gas to be absorbed into an absorbing liquid containing an amine;
a first washer configured to wash the combustion exhaust gas from the carbon dioxide capturer with a mist of a first cleaning liquid sprayed by a spray to capture the amine contained in the combustion exhaust gas; and
a cleaning liquid mist capturer configured to capture the mist of the first cleaning liquid contained in the combustion exhaust gas from the first washer,
wherein the first washer has a receiver arranged below the spray and configured to receive the mist of the first cleaning liquid, and a washing-capturing space arranged between the spray and the receiver, in the washing-capturing space the mist of the first cleaning liquid comes into gas-liquid contact with the combustion exhaust gas while freely dropping.

2. The carbon dioxide capture system according to claim 1, further comprising: a washer exit demister configured to trap the amine contained in the combustion exhaust gas from the cleaning liquid mist capturer.

3. The carbon dioxide capture system according to claim 2, wherein a vertical length of the cleaning liquid mist capturer is shorter than a vertical length of the carbon dioxide capturer.

4. The carbon dioxide capture system according to claim 2, wherein
the cleaning liquid mist capturer includes a mist capture demister, and
the mist capture demister is formed more sparsely than the washer exit demister.

5. The carbon dioxide capture system according to claim 1, further comprising: a second washer configured to wash the combustion exhaust gas from the cleaning liquid mist capturer with a second cleaning liquid diffused and dropped by a cleaning liquid diffuser to capture the amine contained in the combustion exhaust gas.

6. The carbon dioxide capture system according to claim 5, wherein a pressure of the first cleaning liquid supplied to the spray of the first washer is higher than a pressure of the second cleaning liquid supplied to the cleaning liquid diffuser of the second washer.

7. The carbon dioxide capture system according to claim 5, wherein a flow rate per unit area and unit time of the first cleaning liquid sprayed from the spray is larger than a flow rate per unit area and unit time of the second cleaning liquid diffused from the cleaning liquid diffuser.

8. The carbon dioxide capture system according to claim 5, further comprising: a bypass line configured to mix a part of the second cleaning liquid into the first cleaning liquid.

9. The carbon dioxide capture system according to claim 1, wherein
the carbon dioxide capturer and the first washer are each formed in a cylindrical shape, and
a diameter of the first washer is larger than a diameter of the carbon dioxide capturer.

10. The carbon dioxide capture system according to claim 1, further comprising:
an absorption column housing the carbon dioxide capturer; and
a washing column housing the first washer and the cleaning liquid mist capturer, wherein
in the washing column, a rectifier rectifying a flow of the combustion exhaust gas introduced into the washing column is arranged below the first washer.

11. A method of operating a carbon dioxide capture system, comprising:
causing a carbon dioxide contained in a combustion exhaust gas to be absorbed into an absorbing liquid containing an amine in a carbon dioxide capturer;
washing the combustion exhaust gas from the carbon dioxide capturer with a mist of a first cleaning liquid sprayed by a spray in a first washer to capture the amine contained in the combustion exhaust gas; and
capturing the mist of the first cleaning liquid contained in the combustion exhaust gas from the first washer,
wherein the first washer has a receiver arranged below the spray and configured to receive the mist of the first cleaning liquid, and a washing-capturing space arranged between the spray and the receiver, in the washing-capturing space the mist of the first cleaning liquid comes into gas-liquid contact with the combustion exhaust gas while freely dropping.
